(19) United States
(12) Patent Application Publication
(10) Pub. No.: US 2021/0061041 A1
(43) Pub. Date: Mar. 4, 2021

(54) STEERING CONTROL DEVICE AND STEERING DEVICE

(71) Applicant: SHOWA CORPORATION, Saitama (JP)

(72) Inventors: Kyouichi TAGAMI, Tochigi (JP); Ken ISSHIKI, Tochigi (JP); Nobuyuki ENOMOTO, Tochigi (JP); Eishi ISHIMARU, Tochigi (JP)

(21) Appl. No.: 17/095,219

(22) Filed: Nov. 11, 2020

Related U.S. Application Data
(63) Continuation of application No. PCT/JP2018/032867, filed on Sep. 5, 2018.

(30) Foreign Application Priority Data
Jun. 29, 2018 (JP) 2018-124556

(51) Int. Cl. B60G 17/0195; B62D 5/04; B62D 6/04; B60G 17/06

(52) U.S. Cl. CPC B60G 17/0195; B62D 5/0457; B62D 6/04; B60G 2500/40; B60G 2400/42; B60G 2400/518; B60G 2500/10; B60G 17/06

(57) ABSTRACT

An embodiment of the present invention allows for application of an assist torque or reaction torque which causes a driver to feel less discomfort. An ECU (600) includes a rack shaft axial force estimating section (620) configured to estimate a rack shaft axial force with reference to a roll rate of a vehicle body.

This application is a Continuation of PCT International Application No. PCT/JP2018/032867 filed in Japan on Sep. 5, 2018, which claims the benefit of Patent Application No. 2018-124556 filed in Japan on Jun. 29, 2018, the entire contents of which are hereby incorporated by reference.

### TECHNICAL FIELD

The present invention relates to (i) a steering control device for applying an assist torque or reaction torque to a steering member, and (ii) a steering device.

### BACKGROUND ART

Steering devices which apply an assist torque or a reaction torque to a steering member have been known. Further, in relation to steering devices, Patent Literature 1 discloses a technique for estimating a rack shaft axial force in turn steering of a tire on the basis of a steering angle and a vehicle speed.

### CITATION LIST

### Patent Literature

[Patent Literature 1]

Japanese Patent Application Publication, Tokukai, No. 2010-100079 (Publication Date: May 6, 2010)

### SUMMARY OF INVENTION

### Technical Problem

With regard to a control device for applying an assist torque or reaction torque to a steering member, it is preferable to apply, to the steering member, an assist torque or reaction torque which causes a driver of a vehicle to feel less discomfort.

An object of an embodiment of the present invention is to provide a control device for applying, to a steering member, an assist torque or reaction torque which causes a driver to feel less discomfort.

### Solution to Problem

In order to attain the above object, an embodiment of the present invention is directed to a steering control device which applies an assist torque or reaction torque to a steering member operated by a driver, the steering control device including: a rack shaft axial force estimating section configured to estimate a rack shaft axial force with reference to a roll rate of a vehicle body.

Further, in order to attain the above object, an embodiment of the present invention is directed to a steering device, including: a steering member operated by a driver; and a steering control section configured to apply an assist torque or reaction torque to the steering member, the steering control section including a rack shaft axial force estimating section configured to estimate a rack shaft axial force with reference to a roll rate of a vehicle body.

### Advantageous Effects of Invention

An embodiment of the present invention makes it possible to apply an assist torque or reaction torque which causes a driver to feel less discomfort.

### BRIEF DESCRIPTION OF DRAWINGS

FIG. 1 is a diagram schematically illustrating a configuration of a vehicle in accordance with Embodiment 1 of the present invention.

FIG. 2 is a block diagram schematically illustrating an ECU in accordance with Embodiment 1 of the present invention.

FIG. 3 is a block diagram illustrating an example configuration of a steering control section in accordance with Embodiment 1 of the present invention.

FIG. 4 is a diagram illustrating a mechanism related to a change in a motion of a vehicle when a rolling motion occurs. (a) of FIG. 4 illustrates a state of the vehicle moving forward, (b) of FIG. 4 illustrates a state of the vehicle turning and rolling, and (c) of FIG. 4 illustrates a relation between a roll angle and a suspension stroke.

FIG. 5 is a diagram illustrating a mechanism related to a change in a force when a rolling motion occurs. (a) of FIG. 5 illustrates a relation between a cornering force and a tire lateral force, and (b) of FIG. 5 illustrates a relation between a cornering force and a rack shaft axial force.

FIG. 6 is a block diagram illustrating an example configuration of a suspension control section in accordance with Embodiment 1 of the present invention.

FIG. 7 is a block diagram illustrating an example configuration of a steering control section in accordance with Embodiment 2 of the present invention.

FIG. 8 is a block diagram illustrating an example configuration of a steering control section in accordance with Embodiment 3 of the present invention.

### DESCRIPTION OF EMBODIMENTS

### Embodiment 1

The following description will discuss Embodiment 1 of the present invention in detail.

(Configuration of Vehicle 900)

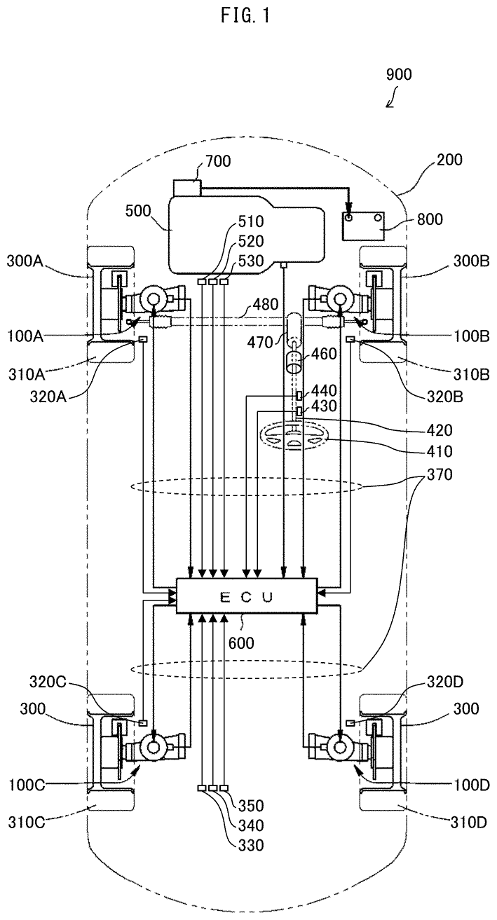

FIG. 1 is a diagram schematically illustrating a configuration of a vehicle 900 in accordance with Embodiment 1 of the present invention. As illustrated in FIG. 1, the vehicle 900 includes suspensions 100, a vehicle body 200, wheels 300, tires 310, a steering member 410, a steering shaft 420, a torque sensor 430, a rudder angle sensor 440, a torque applying section 460, a rack and pinion mechanism 470, a rack shaft 480, an engine 500, an electronic control unit (ECU) (control device) 600, a power-generating device 700 and a battery 800.

The wheels 300 to which the tires 310 are attached are suspended on the vehicle body 200 by the suspensions 100. Since the vehicle 900 is a four-wheeled vehicle, four of a set including a suspension 100, a wheel 300, and a tire 310 are provided.

Note that each of a left front wheel, a right front wheel, a left rear wheel, and a right rear wheel includes a tire and a wheel, which are referred to as a tire 310A and a wheel 300A, a tire 310B and a wheel 300B, a tire 310C and a wheel 300C, or a tire 310D and a wheel 300D. Similarly, respective configurations associated with the left front wheel, the right front wheel, the left rear wheel, and the right rear wheel are denoted by signs “A”, “B”, “C”, and “D”.

The suspension 100 includes a hydraulic shock absorber, an upper arm and a lower arm. Further, the hydraulic shock absorber includes a solenoid valve which is an electromagnetic valve for adjusting a damping force which is caused by the hydraulic shock absorber. This, however, by no means limits Embodiment 1. The hydraulic shock absorber can employ an electromagnetic valve other than the solenoid valve, as the electromagnetic valve for adjusting a damping force. For example, the hydraulic shock absorber can be configured to include, as the electromagnetic valve, an electromagnetic valve which utilizes electromagnetic fluid (magnetic fluid).

The power-generating device 700 is attached to the engine 500. Power generated by the power-generating device 700 is accumulated in the battery 800.

The steering member 410 which a driver operates is connected to one end of the steering shaft 420 so as to be capable of transmitting torque. Meanwhile, the other end of the steering shaft 420 is connected to the rack and pinion mechanism 470.

The rack and pinion mechanism 470 is a mechanism for converting rotation of the steering shaft 420 about an axis of the steering shaft 420 to displacement of the rack shaft 480 along a direction of an axis of the rack shaft 480. When the rack shaft 480 is displaced along the direction of the axis of the rack shaft 480, the wheel 300A and the wheel 300B are turned via a tie rod and a knuckle arm.

The torque sensor 430 detects a steering torque which is applied to the steering shaft 420, that is, a steering torque which is applied to the steering member 410, and supplies, to the ECU 600, a torque sensor signal indicative of a result of this detection. More specifically, the torque sensor 430 detects a torsion of a torsion bar, which is provided in the steering shaft 420, and outputs a result of this detection as the torque sensor signal. Note that the torque sensor 430 can be a well-known sensor such as a hall IC, an MR element, or a magnetostrictive torque sensor.

The rudder angle sensor 440 detects a rudder angle of the steering member 410, and supplies a result of this detection to the ECU 600.

The torque applying section 460 applies, to the steering shaft 420, an assist torque or a reaction torque in accordance with a steering control variable which is supplied from the ECU 600. The torque applying section 460 includes a motor for generating the assist torque or the reaction torque in accordance with the steering control variable, and a torque transmission mechanism for transmitting the torque generated by the motor to the steering shaft 420.

Note that, specific examples of the “control variable” herein encompass a current value, a duty ratio, a damping rate, and a damping ratio.

The steering member 410, the steering shaft 420, the torque sensor 430, the rudder angle sensor 440, the torque applying section 460, the rack and pinion mechanism 470, the rack shaft 480, and the ECU 600 constitute a steering device in accordance with Embodiment 1.

Note that the expression “connected . . . so as to be capable of transmitting torque” in the above description means that two members are connected to each other such that rotation of one of the two members causes rotation of the other one of the two members. Example cases of such a connection encompass at least a case where the two members are integrally formed, a case where one of the two members is directly or indirectly fixed to the other one of the two members, and a case where the two members are connected to each other via a joint member or the like so as to interlock with each other.

Though steering devices described as examples above are each a steering device in which members from the steering member 410 to the rack shaft 480 are always mechanically connected to one another, this configuration by no means limits Embodiment 1. The steering device in accordance with Embodiment 1 can be, for example, a steering device of a steering by wire system. The matters described below in the present specification are applicable to steering devices of a steering by wire system.

The ECU 600 carries out overall control of various electronic devices of the vehicle 900. More specifically, the ECU 600 controls a magnitude of the assist torque or the reaction torque to be applied to the steering shaft 420, by adjusting the steering control variable to be supplied to the torque applying section 460.

Further, the ECU 600 supplies a suspension control variable to the solenoid valve which is provided in the hydraulic shock absorber in the suspension 100, so as to control opening/closing of the solenoid valve. In order to allow for this control, an electrical power line is provided. The electric power line is used for supplying a drive power from the ECU 600 to the solenoid valve.

Further, the vehicle 900 includes a wheel speed sensor 320 which is provided for each of the wheels 300 and detects a wheel speed of each wheel 300, a lateral G sensor 330 which detects an acceleration in a lateral direction of the vehicle 900, a longitudinal G sensor 340 which detects an acceleration in a longitudinal direction of the vehicle 900, a yaw rate sensor 350 which detects a yaw rate of the vehicle 900, an engine torque sensor 510 which detects a torque generated by the engine 500, an engine speed sensor 520 which detects the number of rotations of the engine 500, and a brake pressure sensor 530 which detects a pressure applied to brake fluid provided in a brake device. Results of detection by the above various sensors are supplied to the ECU 600.

Note that the vehicle 900 may further include a roll rate sensor which detects a roll rate of the vehicle body 200 and a stroke sensor which detects a stroke of each of the suspensions.

Note that though not illustrated, the vehicle 900 includes a brake device which can be controlled by an antilock brake system (ABS), a traction control system (TCS), and a vehicle stability assist (VSA). The antilock brake system (ABS) prevents the wheels from locking up in breaking. The traction control system (TCS) prevents wheel slip of the wheels in acceleration of the vehicle 900. The vehicle stability assist (VSA) is a control system for stabilizing vehicle behavior, which system has an automatic braking function for, for example, yaw moment control in turning and a brake assist function.

The ABS, TCS, and VSA here compare a wheel speed determined in accordance with an estimated vehicle body speed and a wheel speed detected by the wheel speed sensor 320, and determines that the vehicle 900 is slipping in a case where a difference between respective values of these two wheel speeds is not less than a predetermined value. The ABS, the TCS, and the VSA are intended to stabilize the behavior of the vehicle 900, by carrying out the most appropriate brake control and traction control in accordance with a running state of the vehicle 900 through the above process.

Further, supply of the results of detection by the above various sensors to the ECU 600 and transmission of control signals from the ECU 600 to each section are carried out via a controller area network (CAN) 370.

(ECU 600)

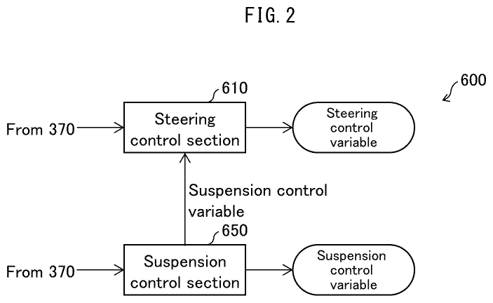

The following will specifically discuss the ECU 600 with reference to another drawing. FIG. 2 is a diagram schematically illustrating the ECU 600.

A steering control section 610 refers to the results of detection by the various sensors in the CAN 370, and determines a level of the steering control variable which is to be supplied to the torque applying section 460.

Note that as used herein, the wording “referring to” may mean “using”, “considering”, “depending on” or the like.

A suspension control section 650 refers to the results of detection by the various sensors in the CAN 370, and determines a level of the suspension control variable which is to be supplied to the solenoid valve provided in the hydraulic shock absorber of the suspension 100.

Further, as illustrated in FIG. 2, in the ECU 600, the suspension control variable calculated by the suspension control section 650 is supplied to the steering control section 610. Then, the steering control section 610 refers to the suspension control variable so as to determine the level of the steering control variable.

Note that a roll rate value can be configured to express a roll rate as a shift from a reference value of “0” which is a value in a case where inclination of the vehicle 900 has not changed for a predetermined minute time.

Further, the process of “determining a level of the control variable” includes a case where the level of the control variable is set to zero, that is, a case where no control variable is supplied.

Alternatively, it is possible to have a configuration in which the steering control section 610 and the suspension control section 650 are realized by separate ECUs, respectively. In this case, the steering control section 610 and the suspension control section 650 communicate with each other by use of communication means, so that control described in the present specification is carried out.

(Steering Control Section)

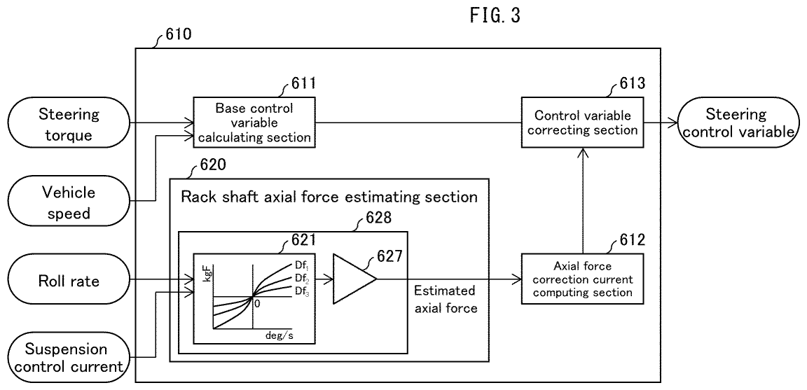

Next, the following will more specifically discuss the steering control section 610 with reference to FIG. 3. FIG. 3 is a block diagram illustrating an example configuration of the steering control section 610.

As illustrated in FIG. 3, the steering control section 610 includes a base control variable calculating section 611, an axial force correction current computing section 612, a control variable correcting section 613, and a rack shaft axial force estimating section 620.

The base control variable calculating section 611 calculates a control variable for controlling the magnitude of the assist torque or reaction torque, with reference to the steering torque supplied from the torque sensor 430 and the vehicle speed determined on the basis of the wheel speed detected by the wheel speed sensor 320. The control variable calculated by the base control variable calculating section 611 is supplied to the torque applying section 460 as the steering control variable, after the control variable is corrected by the control variable correcting section 613.

(Rack shaft axial force estimating section) The rack shaft axial force estimating section 620 estimates a rack shaft axial force with reference to the roll rate supplied from the roll rate sensor. As illustrated in FIG. 3, the rack shaft axial force estimating section 620 includes a roll rate-related suspension damping force estimating section 621 and a first constant gain applying section 627. Note that the roll rate-related suspension damping force estimating section 621 and the first constant gain applying section 627 may be collectively referred to as a roll rate-related rack shaft axial force estimating section 628 (“first rack shaft axial force estimating section” in the Claims).

The roll rate-related suspension damping force estimating section 621 estimates a damping force of the suspension in accordance with the roll rate, with reference to a roll rate map illustrated in FIG. 3. The roll rate map is a map which receives a roll rate and outputs an estimated value of the damping force of the suspension in accordance with the roll rate. In the roll rate map, a horizontal axis represents a roll rate and a vertical axis represents an estimated value of the damping force of the suspension. In FIG. 3, Df₁ through Df₃ each represent a value of a suspension control current which serves as the suspension control variable. It can be said that Df₁ through Df₃ are values related to a damping coefficient.

Note here that the “damping coefficient” is a numerical representation of a damping property, which is a property representing a relation between a stroke speed of a damper and a damping force, and the “damping force” is a resistance exerted when the hydraulic shock absorber is pushed and pulled.

Thus, the roll rate-related suspension damping force estimating section 621 refers to any of various roll rate maps in accordance with a value of the suspension control variable. By referring to the roll rate map, the roll rate-related suspension damping force estimating section 621 calculates, on the basis of a roll rate, an estimated value of the damping force of the suspension in accordance with the roll rate, and outputs the estimated value of the damping force of the suspension thus calculated to the first constant gain applying section 627. The first constant gain applying section 627 calculates an estimated rack shaft axial force on the basis of the estimated value of the damping force of the suspension in accordance with the roll rate, and outputs the estimated rack shaft axial force.

The first constant gain applying section 627 applies a gain in accordance with the vehicle 900 to the estimated value of the damping force of the suspension in accordance with the roll rate. More specifically, the first constant gain applying section 627 multiplies the estimated value of the suspension supplied from the roll rate-related suspension damping force estimating section 621 by a correction factor in accordance with the vehicle 900. Examples of the correction factor in accordance with the vehicle 900 encompass a gain in accordance with a caster angle β, a knuckle length Lkn, a tread width TW, a height Hg of a center of gravity, or the like.

Further, the rack shaft axial force estimating section 620 may estimate the rack shaft axial force in accordance with the roll rate with further reference to the suspension control current. In such a case, the roll rate map referred to by the roll rate-related suspension damping force estimating section 621 is a map which receives the roll rate and the suspension control current and outputs the estimated value of the damping force of the suspension in accordance with the roll rate. By referring to the roll rate map, the roll rate-related suspension damping force estimating section 621 calculates, on the basis of the roll rate supplied from the roll rate sensor and the suspension control current supplied from the suspension control section 650, the estimated value of the damping force of the suspension in accordance with the roll rate, and outputs the estimated value to the first constant gain applying section 627. The first constant gain applying section 627 calculates the estimated rack shaft axial force on the basis of the estimated value of the damping force of the suspension in accordance with the roll rate, and outputs the estimated rack shaft axial force.

Note here that the greater the suspension control current, the greater the estimated value of the damping force of the suspension calculated and outputted by the roll rate-related suspension damping force estimating section 621.

In other words, the greater the suspension control current, the greater the estimated rack shaft axial force calculated and outputted by the rack shaft axial force estimating section 620.

The axial force correction current computing section 612 calculates a value of a correction current in accordance with the rack shaft axial force estimated by the rack shaft axial force estimating section 620.

The control variable correcting section 613 generates the steering control variable by correcting, with use of the correction current supplied from the axial force correction current computing section 612, the control variable calculated by the base control variable calculating section 611. In other words, the control variable correcting section 613 corrects, with reference to the rack shaft axial force estimated by the rack shaft axial force estimating section 620, the control variable calculated by the base control variable calculating section 611.

In this way, the control variable correcting section 613 corrects the control variable calculated by the base control variable calculating section 611, with reference to the rack shaft axial force estimated by the rack shaft axial force estimating section 620. This makes it possible to apply, to the steering member 410, an assist torque or reaction torque which causes a driver to feel less discomfort.

Further, the steering control section 610 in accordance with Embodiment 1 can estimate a direction in which the vehicle body 200 is rolling, by estimating the rack shaft axial force with reference to the roll rate of the vehicle body 200. Accordingly, the steering control section 610 can identify a roll change in a transient state of the vehicle body 200. In this way, the control variable correcting section 613 corrects the control variable calculated by the base control variable calculating section 611, in accordance with the roll change in the transient state of the vehicle body 200. This makes it possible to apply, to the steering member 410, an assist torque or reaction torque which causes a driver to feel less discomfort.

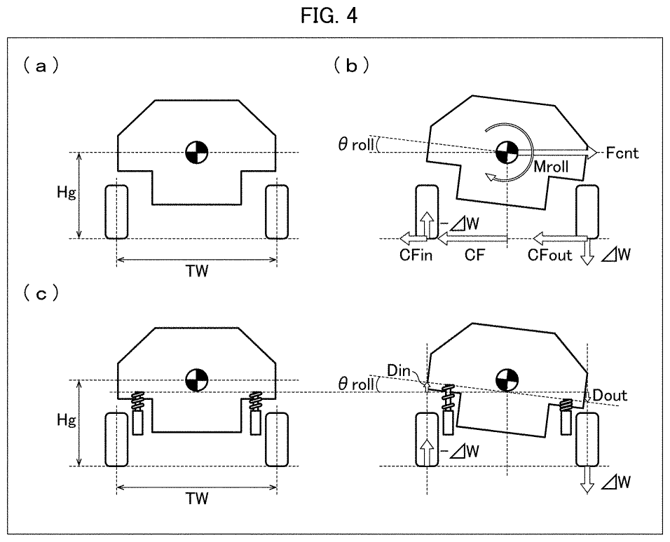

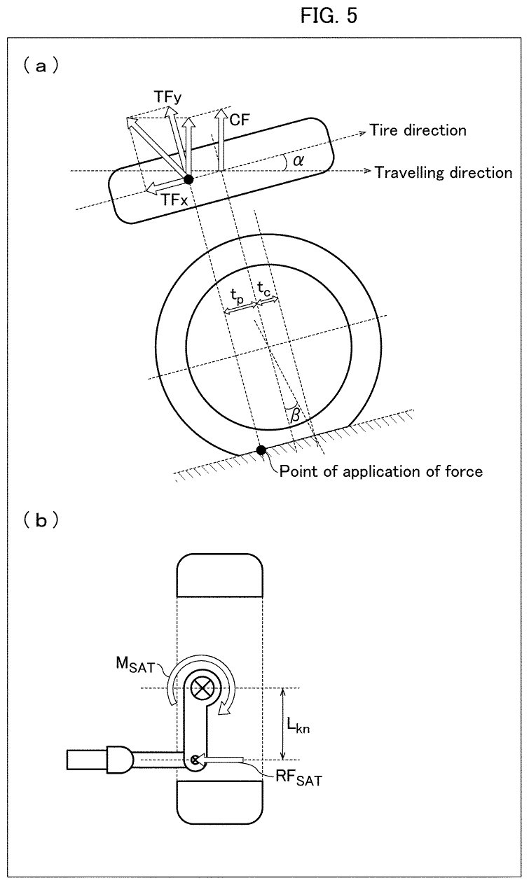

(Method for computing estimated rack shaft axial force) Next, the following will discuss, with reference to FIGS. 4 and 5, a method for computing an estimated rack shaft axial force in more detail. First with reference to FIG. 4, the following will discuss a mechanism in terms of a change in a motion of the vehicle when a rolling motion occurs.

FIG. 4 is a diagram illustrating a mechanism related to a change in a motion of the vehicle when a rolling motion occurs. (a) of FIG. 4 illustrates a state of the vehicle moving forward, (b) of FIG. 4 illustrates a state of the vehicle turning and rolling, and (c) of FIG. 4 illustrates a relation between a roll angle and a suspension stroke.

As illustrated in FIG. 4, when the vehicle is in a state where the vehicle is turning and rolling, in other words, when the vehicle 900 is in a state in which the steering member 410 is being operated by a driver, a tire cornering force, a lateral G, a centrifugal force, a roll moment, and a load shift are generated. In FIG. 4, a height of a center of gravity of the vehicle 900 is represented as Hg [m], a tread width of the vehicle 900 is represented as TW [m], a cornering force of a total of the four wheels of the vehicle 900 is represented as CF [kgf], an inner wheel-side cornering force of the vehicle 900 is represented as CFᵢₙ [kgf], an outer wheel-side cornering force of the vehicle 900 is represented as CFₒᵤₜ [kgf], a centrifugal force is represented as Fₑₙₜ [kgf], a lateral G is represented as Gy [G′], a roll moment is represented as Mᵣₒₗₗ [kgf·m], a load shift is represented as ΔW [kgf], a roll angle is represented as θᵣₒₗₗ [deg], an inner wheel-side stroke amount is represented as Dᵢₙ [m], and an outer-wheel side stroke amount is represented as Dₒᵤₜ [m].

As illustrated in (b) of FIG. 4, the centrifugal force and the tire cornering force of the vehicle 900 which is turning are balanced with each other and represented by the following Formula (1).

$$\begin{matrix}Fcnt [ kgf ] = Wca r [ k g ] \times Gy [ {G}^{′} ] \\ = C F [ kgf ] \end{matrix} \qquad ( 1 )$$

The roll moment is represented by the following Formulae (2) and (3).

Mroll[kgfm]=CF[kgf]×Hg[m] (2)

Mroll[kgfm]=2×(ΔW[kgf]×TW/2[m]) (3)

The following Formula (4) is given by simultaneously solving the Formulae (2) and (3) with respect to Mᵣₒₗₗ.

$$Δ W [ kgf ] = Mrol \vert [ kgfm ] \div TW [ m ] = \frac{CF [ kgf ] \times Hg [ m ]}{TW [ m ]} \qquad ( 4 )$$

In a case where a ratio of a load on the front wheels and a load on the rear wheels is a:b, loads applied to the respective wheels are as follows.

$$\begin{matrix}\begin{matrix}Load on front \\ inner wheel\end{matrix} = 1 \text{/} 2 \times a \times Wcar - a \times Δ W & \begin{matrix}Load on front \\ out er wheel\end{matrix} = 1 \text{/} 2 \times a \times Wcar + a \times Δ W \\ \begin{matrix}Load on rear \\ inner wheel\end{matrix} = 1 \text{/} 2 \times b \times Wcar - b \times Δ W & \begin{matrix}Load on rear \\ out er wheel\end{matrix} = 1 \text{/} 2 \times b \times Wcar + b \times Δ W\end{matrix}$$

Note that W_{car} represents a weight of the vehicle 900. ½×a×W_{car} and ½×a×W_{car} each represent an amount of a load in a 1G state, and −a×ΔW, −b×ΔW, a×ΔW, and b×ΔW each represent an amount of a load shift.

As illustrated in (c) of FIG. 4, a roll angle formed by a stroke of a suspension 100 at an inner wheel and a stroke of a suspension 100 at an outer wheel is represented by the following Formula (5).

$${θ}_{roll} [ deg ] = {tan}^{- 1} ( \frac{{D}_{out} [ m ] - {D}_{in} [ m ]}{TW [ m ]} ) \qquad ( 5 )$$

A relational formula indicative of a relation between a load shift and a stroke amount is represented by the following Formula (6). Note that the Formula (6) is a relational formula indicative of a relation between a load shift and a stroke amount on a front wheel side.

$$- a \times Δ W [ kgf ] = - {DF}_{fr} \times \frac{d {D}_{in}}{dt} - {K}_{fr} \times {D}_{in} … Inner wheel side \\ a \times Δ W [ kgf ] = {DF}_{fr} \times \frac{d {D}_{out}}{dt} + {K}_{fr} \times {D}_{out} … O uter wheel side \qquad ( 6 )$$

Note that DF_{fr} represents a front wheel damping coefficient [kgfs/m], and K_{fr} represents a front wheel spring coefficient [kgf/m].

In a case where (i) a stroke amount of stretching of a suspension 100 at an inner wheel is equivalent to a stroke amount of contraction of a suspension 100 at an outer wheel and (ii) a stroke amount of contraction of a suspension 100 at an inner wheel is equivalent to a stroke amount of stretching of a suspension 100 at an outer wheel, that is, in a case where (i) a stroke amount of stretching on the left side is equivalent to a stroke amount of contraction on the right side and (ii) a stroke amount of contraction on the left side is equivalent to a stroke amount of stretching on the right side, the following Formula (7) holds.

−Dᵢₙ≅Dₒᵤₜ≅D_{eq} (7)

Note that D_{eq} represents an equivalent stroke amount [m].

Applying the Formula (7) to the formula (5) to approximate the trigonometric function to a straight line gives the following Formula (8).

$${θ}_{roll} [ deg ] = {tan}^{- 1} ( \frac{2 {D}_{eq} [ m ]}{TW [ m ]} ) \\ {D}_{eq} [ m ] = \frac{tan ( {θ}_{roll} [ deg ] ) \times TW [ m ]}{2} ≅ {K}_{tan} [ 1 \text{/} deg ] \times {θ}_{roll} [ deg ] \times \frac{TW [ m ]}{2} \qquad ( 8 )$$

Further, applying the Formula (7) to the Formula (6) gives the following Formula (9).

$$\begin{matrix}a \times Δ W = {DF}_{fr} \times \frac{{dD}_{eq}}{dt} + {K}_{fr} \times {D}_{eq} \\ = {DF}_{fr} \times \frac{{K}_{tan} \times TW [ m ]}{2} \times \frac{d}{dt} ( {θ}_{roll} [ deg ] ) + \\ {K}_{fr} \times \frac{{K}_{tan} \times TW [ m ]}{2} \times {θ}_{roll} [ deg ]\end{matrix} \qquad ( 9 )$$

Note that

$$\frac{d}{dt} ( {θ}_{roll} [ deg ] ) = {ω}_{roll} [ deg \text{/} sec ]$$

represents a roll rate.

Since the damping coefficient DF_{fr} is determined by a damper property with use of a stroke speed and an electric current, in the Formula (9),

$${DF}_{fr} \times \frac{{K}_{tan} \times TW [ m ]}{2} \times \frac{d}{dt} ( {θ}_{roll} [ deg ] )$$

is replaced with

f_{DFfr}(ω,i)

Further, another replacement is made in the Formula (9) such that

$$\frac{d}{dt} ( {θ}_{roll} [ deg ] ) = {ω}_{roll} [ deg \text{/} sec ] , \frac{{K}_{tan} \times TW [ m ]}{2} = {K}_{1}$$

to reorganize the Formula (9) to obtain the following Formula (10).

a×ΔW=f_{DFfr}(K₁×ωᵣₒₗₗ[deg/sec],i_{Dfr})+K_{fr}+K₁×θᵣₒₗₗ[deg] (10)

By substituting the Formula (4) into the Formula (10), the following Formula (11), which is a relational formula related to a change in a motion of the vehicle, can be obtained.

$$\frac{a \times {H}_{g} [ m ]}{TW [ m ]} \times CF [ kgf ] = {f}_{DFfr} ( {K}_{1} \times {ω}_{roll} [ deg \text{/} sec ] , {i}_{Dfr} ) + {K}_{fr} \times {K}_{1} \times {θ}_{roll} [ deg ] \qquad ( 11 )$$

Next, with reference to FIG. 5, the following will discuss a mechanism in terms of a change in a force when a rolling motion occurs. FIG. 5 is a diagram illustrating a mechanism related to a change in a force when a rolling motion occurs. (a) of FIG. 5 illustrates a relation between a cornering force and a tire lateral force, and (b) of FIG. 5 illustrates a relation of a rack shaft axial force. In FIG. 5, the cornering force is represented as CF [kgf], the tire lateral force is represented as TF_{y} [kgf], an angle of sideslip is represented as a [° ], a tire rolling resistance is represented as TFₓ [kgf], a pneumatic trail is represented as tₚ [m], a caster trail is represented as t_{c} [m], a caster angle is represented as β [°], a SAT moment (a moment generated by a tire lateral force) is represented as M_{SAT} [kgf·m], a rack shaft axial force is represented as RF_{SAT} [kgf], and a knuckle length is represented as Lₖₙ [m]. Note that the pneumatic trail tₚ decreases when the angle of sideslip α exceeds a predetermined value. This decrease in the pneumatic trail tₚ causes a decrease in the SAT moment M_{SAT}.

A relational formula indicative of a relation between the cornering force, the tire lateral force, and the rolling resistance is represented by the following Formula (12).

CF[kgf]=TF_{y}[kgf]×cos α−TFₓ[kgf]×sin α (12)

Further, the SAT moment generated by the tire lateral force about an axis of a kingpin is represented by the following Formula (13).

M_{SAT}[kgfm]=TF_{y}[kgf]×(tₚ[m]+t_{c}[m])×sin β (13)

Further, the rack shaft axial force is represented by the following Formula (14).

RF_{SAT}[kgf]≈M_{SAT}[kgfm]+Lₖₘ[m] (14)

The Formula (13) is substituted into the Formula (14). Here, in a case where the angle of sideslip is small and

cos α≈1, sin α≅0

,

CF[kgf]≈TF_{y}[kgf]

Thus, the following Formula (15), which is a relational formula related to a change in a force, can be obtained.

$${RF}_{SAT} [ kgf ] ≅ CF [ kgf ] \times \frac{( {t}_{p} [ m ] + {t}_{c} [ m ] ) \times sin β}{{L}_{kn} [ m ]} \qquad ( 15 )$$

By simultaneously solving the relational Formulae (11) and (15) with respect to CF, the following Formula (16) can be obtained.

$${RF}_{SAT} [ kgf ] ≅ \{ {f}_{DFfr} ( {K}_{1} \times {ω}_{roll} [ deg \text{/} sec ] , {i}_{Dfr} ) + {K}_{fr} \times {K}_{1} \times {θ}_{roll} [ deg ] \} \times ( {t}_{p} [ m ] + {t}_{c} [ m ] ) \times \frac{TW [ m ] \times sin β}{a \times {H}_{g} [ m ] \times {L}_{kn} [ m ]} \qquad ( 16 )$$

With use of the Formula (16), the rack shaft axial force estimating section 620 can output the estimated rack shaft axial force by receiving a roll rate, a roll angle, and a coefficient in accordance with the vehicle 900. Note that the estimated rack shaft axial force (a roll rate-related estimated rack shaft axial force; “first rack shaft axial force” in the Claims) related to the roll rate and estimated by the roll rate-related rack shaft axial force estimating section 628 corresponds to

$${f}_{DFfr} ( {K}_{1} \times {ω}_{roll} [ deg \text{/} sec ] , {i}_{Dfr} ) \times \frac{TW [ m ] \times sin β}{a \times {H}_{g} [ m ] \times {L}_{kn} [ m ]}$$

in the Formula (16). Further, an estimated rack shaft axial force (a roll angle-related estimated rack shaft axial force; “first rack shaft axial force” in the Claims) related to a roll angle and estimated by a roll angle-related rack shaft axial force estimating section 622 (“second rack shaft axial force estimating section” in the Claims) which will be described later in Embodiment 2 corresponds to

$${K}_{fr} \times {K}_{1} \times {θ}_{roll} [ deg ] \times \frac{TW [ m ] \times sin β}{a \times {H}_{g} [ m ] \times {L}_{kn} [ m ]}$$

in the Formula (16). Further, a correction factor determined by a trail map applying section 624 which will be described later in Embodiment 3 corresponds to

tₚ[m]+t_{c}[m]

in the Formula (16). Further, a correction factor determined by a second constant gain applying section 626 (described later) corresponds to

$$\frac{TW [ m ] \times sin β}{a \times {H}_{g} [ m ] \times {L}_{kn} [ m ]}$$

### in the Formula (16).

(Suspension Control Section)

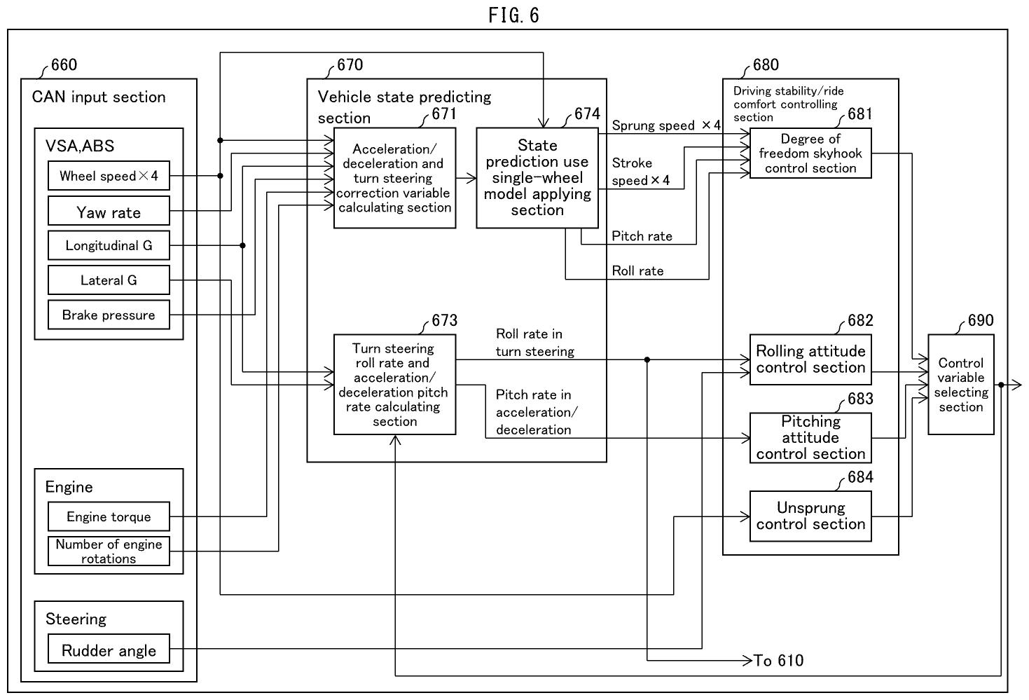

Next, the following will discuss a suspension control section with reference to FIG. 6. FIG. 6 is a block diagram illustrating an example configuration of the suspension control section 650.

The suspension control section 650 includes a CAN input section 660, a vehicle state predicting section 670, a driving stability/ride comfort controlling section 680, and a control variable selecting section 690, as illustrated in FIG. 6.

The CAN input section 660 obtains various signals via the CAN 370. As illustrated in FIG. 6, the CAN input section 660 obtains the following signals (sensors in parentheses are signal sources).
wheel speeds of four wheels (wheel speed sensors 320A to 320D)
yaw rate (yaw rate sensor 350)
longitudinal G (longitudinal G sensor 340)
lateral G (lateral G sensor 330)
brake pressure (brake pressure sensor 530)
engine torque (engine torque sensor 510)
number of engine rotations (engine speed sensor 520)
rudder angle (rudder angle sensor 440)

The vehicle state predicting section 670 predicts the state of the vehicle 900 with reference to the various signals obtained by the CAN input section 660. The vehicle state predicting section 670 outputs, as results of the above prediction, sprung speeds of the four wheels, stroke speeds of the four wheels, a pitch rate, a roll rate, a roll rate in turn steering, and a pitch rate in acceleration/deceleration.

The vehicle state predicting section 670 includes an acceleration/deceleration and turn steering correction variable calculating section 671, a turn steering roll rate and acceleration/deceleration pitch rate calculating section 673, and a state prediction use single-wheel model applying section 674, as illustrated in FIG. 6.

The acceleration/deceleration and turn steering correction variable calculating section 671 calculates, with reference to the yaw rate, the longitudinal G, the wheel speeds of the four wheels, the brake pressure, the engine torque, and the number of rotations of engine, a speed in a longitudinal direction of the vehicle body, a ratio of an inner wheel difference (difference between tracks followed by front and back inner wheels in turning) and an outer wheel difference (difference between tracks followed by front and back outer wheels in turning), and an adjustment gain, and supplies results of the above calculation to the state prediction use single-wheel model applying section 674.

The turn steering roll rate and acceleration/deceleration pitch rate calculating section 673 calculates the roll rate in turn steering and the pitch rate in acceleration/deceleration, with reference to the longitudinal G and the lateral G. Results of this calculation are supplied to the state prediction use single-wheel model applying section 674.

Further, the turn steering roll rate and acceleration/deceleration pitch rate calculating section 673 supplies, as the roll rate value, the roll rate in turn steering thus calculated to the steering control section 610. The turn steering roll rate and acceleration/deceleration pitch rate calculating section 673 can be configured to further refer to the suspension control variable outputted from the control variable selecting section 690. The details of the turn steering roll rate and acceleration/deceleration pitch rate calculating section 673 will be described later with reference to a different drawing.

As described above, the turn steering roll rate and acceleration/deceleration pitch rate calculating section 673 supplies, to the steering control section 610, the roll rate in turn steering, as the roll rate value, which roll rate has been calculated with reference to the longitudinal G and the lateral G. Then, the steering control section 610 corrects the control variable for controlling the magnitude of the assist torque or the reaction torque with reference to the roll rate. This allows the steering control section 610 to more suitably correct the magnitude of the assist torque or the reaction torque.

Further, if the turn steering roll rate and acceleration/deceleration pitch rate calculating section 673 is configured to further refer to the suspension control variable outputted from the control variable selecting section 690 as described above, the steering control section 610 can more suitably correct the magnitude of the assist torque or the reaction torque.

The state prediction use single-wheel model applying section 674 applies, to each wheel, a state prediction use single-wheel model and calculates the sprung speeds of the four wheels, the stroke speeds of the four wheels, the pitch rate, and the roll rate, with reference to the results of the calculation by the acceleration/deceleration and turn steering correction variable calculating section 671. Results of this calculation are supplied to the driving stability/ride comfort controlling section 680.

The driving stability/ride comfort controlling section 680 includes a skyhook control section 681, a rolling attitude control section 682, a pitching attitude control section 683, and an unsprung control section 684.

The skyhook control section 681 suppresses shaking of the vehicle when the vehicle goes over a bumpy road surface and carries out ride comfort control (damping control) for increasing ride comfort. The skyhook control section 681 determines a desired skyhook control variable, with reference to, for example, the sprung speeds of the four wheels, the stroke speeds of the four wheels, the pitch rate, and the roll rate, and supplies a result of this determination to the control variable selecting section 690.

More specifically, for example, the skyhook control section 681 sets a damping force base value on the basis of the sprung speeds with reference to a sprung-damping force map. Further, the skyhook control section 681 calculates a desired skyhook damping force by multiplying, by a skyhook gain, the damping force base value thus set. Then, the skyhook control section 681 determines the desired skyhook control variable on the basis of the desired skyhook damping force and the stroke speeds.

The rolling attitude control section 682 carries out rolling attitude control with reference to the roll rate in turn steering and the rudder angle, and determines a rudder angle proportional desired control variable which is a desired control variable in accordance with the rudder angle, a rudder angle speed proportional desired control variable which is a desired control variable in accordance with the rudder angle speed, and a roll rate proportional desired control variable which is a desired control variable in accordance with the roll rate. Then, the rolling attitude control section 682 supplies results of the above determination to the control variable selecting section 690.

Alternatively, the rolling attitude control section 682 can be configured to calculate various desired control variables described above, with reference to a steering torque signal indicative of the steering torque. It is also possible to have a configuration in which the suspension control section 610 supplies the steering torque signal to the suspension control section 650 and the steering control section 610 refers to the steering torque signal. Note that it is also possible to use a phase-compensated steering torque signal as the torque signal. It can be expected that this configuration will achieve higher ride comfort.

Since the rolling attitude control section 682 carries out rolling attitude control with reference to the roll rate in turn steering which roll rate has been calculated by the turn steering roll rate and acceleration/deceleration pitch rate calculating section 673 as described above, it is possible to carry out a suitable attitude control. Further, the roll rate in turn steering calculated by the turn steering roll rate and acceleration/deceleration pitch rate calculating section 673 is used not only for the rolling attitude control by the rolling attitude control section 682 but also for correction of the magnitude of the assist torque or the reaction torque by the steering control section 610 as described above. This makes it possible to carry out a suitable attitude control and to provide a feeling of comfortable steering while suppressing an increase in the number of constituent elements.

The pitching attitude control section 683 carries out pitching control with reference to the pitch rate in acceleration/deceleration, determines a desired pitching control variable, and then supplies a result of this determination to the control variable selecting section 690.

The unsprung control section 684 carries out damping control below a spring of the vehicle 900 with reference to the wheel speeds of the four wheels, and determines a desired unsprung damping control variable. A result of this determination is supplied to the control variable selecting section 690.

The control variable selecting section 690 outputs, as the suspension control variable, a desired control variable whose value is the largest among the desired skyhook control variable, the rudder angle proportional desired control variable, the rudder angle speed proportional desired control variable, the roll rate proportional desired control variable, the desired pitching control variable, and the desired unsprung damping control variable.

A damping property of the hydraulic shock absorber changes in accordance with the suspension control variable, so that a damping force of the suspension is controlled.

[Variation]

The rack shaft axial force estimating section 620 in accordance with Embodiment 1 may be configured such that as an input to the roll rate-related rack shaft axial force estimating section 628, the rack shaft axial force estimating section 620 uses, in place of the roll rate supplied from the roll rate sensor, a roll rate outputted from the vehicle state predicting section 670 of the suspension control section 650, i.e., a roll rate serving as an estimated value to be referred to in order to calculate a control variable for controlling the damping force of the suspension.

Further, as an input to be inputted to the roll rate-related rack shaft axial force estimating section 628, the rack shaft axial force estimating section 620 in accordance with Embodiment 1 may use, in place of the suspension control current supplied from the suspension control section 650, a sensor value supplied from the stroke sensor. Note that a value related to a damping coefficient, such as a suspension control current and a sensor value of the stroke sensor, is herein referred to as a damping coefficient-related value.

As described above, the rack shaft axial force estimating section 620 in accordance with Embodiment 1 is configured to estimate a rack shaft axial force with use of a roll rate and a damping coefficient-related value. Since the rack shaft axial force estimating section 620 in accordance with Embodiment 1 estimates a rack shaft axial force with use of a roll rate and a damping coefficient-related value, the rack shaft axial force estimating section 620 can suitably estimate a rack shaft axial force.

### Embodiment 2

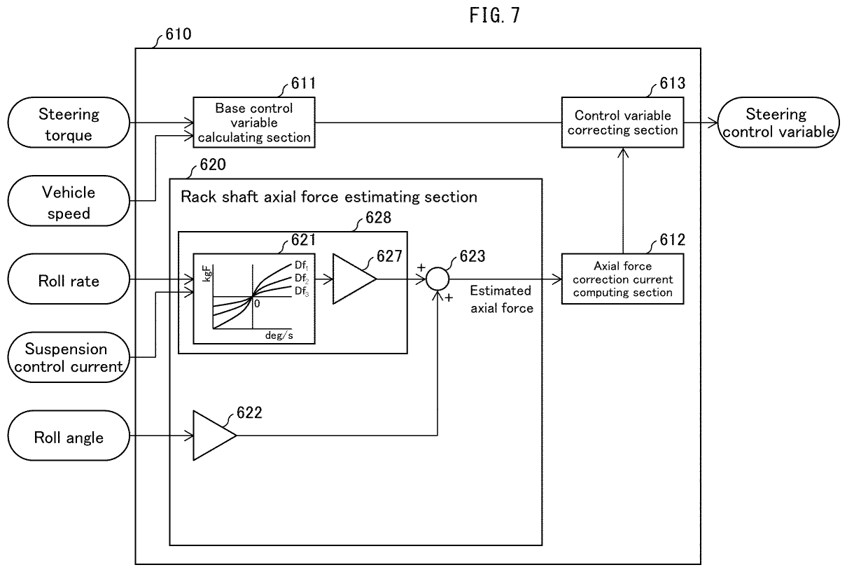

The following description will discuss Embodiment 2 of the present invention with reference to FIG. 7.

FIG. 7 is a block diagram illustrating an example configuration of a steering control section in accordance with Embodiment 2 of the present invention. The steering control section in accordance with Embodiment 2 has a configuration obtained by modifying the steering control section 610 in accordance with Embodiment 1 such that the rack shaft axial force estimating section 620 further includes the roll angle-related rack shaft axial force estimating section 622 and an adding section 623. In the following description, members which are the same as those already discussed are assigned the same referential numerals, and their descriptions are omitted.

As with Embodiment 1, a roll rate-related rack shaft axial force estimating section 628 estimates a rack shaft axial force with reference to a roll rate supplied from a roll rate sensor or a vehicle state predicting section 670, and supplies a roll rate-related estimated rack shaft axial force, which is the rack shaft axial force thus estimated, to the adding section 623.

The roll angle-related rack shaft axial force estimating section 622 estimates a rack shaft axial force with reference to a roll angle, and supplies a roll angle-related estimated rack shaft axial force thus estimated to the adding section 623. Examples of a technique for obtaining the roll angle encompass:
a technique of integrating the roll rate supplied from the roll rate sensor to obtain an integrated value as the roll angle;
a technique of integrating the roll rate outputted from the vehicle state predicting section 670 to obtain an integrated value as the roll angle; and
a technique of employing a configuration in which a vehicle 900 includes a roll angle sensor, and obtaining the roll angle from the roll angle sensor.
   The roll angle-related rack shaft axial force estimating section 622 is configured, for example, to include a roll angle-related damping force estimating section which estimates a damping force from the roll angle and a third constant gain applying section which multiplies, by a gain in accordance with the vehicle 900, a roll angle-related estimated damping force thus estimated. Note, however, that the roll angle-related rack shaft axial force estimating section 622 in accordance with Embodiment 2 is not limited to this. Note that examples of the third constant gain applying section encompass an amplifier.

The adding section 623 adds the roll rate-related estimated rack shaft axial force supplied from the roll rate-related rack shaft axial force estimating section 628 and the roll angle-related estimated rack shaft axial force supplied from the roll angle-related rack shaft axial force estimating section 622 to calculate a rolling-related estimated rack shaft axial force. Note that since the adding section 623 is configured to calculate an estimated rack shaft axial force by adding the roll rate-related estimated rack shaft axial force, which is an estimated rack shaft axial force, and the roll angle-related estimated rack shaft axial force which has been estimated, the adding section 623 can be also referred to as a rolling-related rack shaft axial force estimating section (“third rack shaft axial force estimating section” in the Claims).

As described above, the rack shaft axial force estimating section 620 in accordance with Embodiment 2 can estimate a rack shaft axial force (“third rack shaft axial force” in the Claims) related to rolling with further reference to a roll angle in addition to the roll rate and the damping coefficient-related value described above.

A control variable correcting section 613 generates a steering control variable by correcting, with use of a correction current supplied from an axial force correction current computing section 612, a control variable calculated by a base control variable calculating section 611. In other words, the control variable correcting section 613 corrects the control variable calculated by the base control variable calculating section 611, with reference to the rolling-related estimated rack shaft axial force (an estimated rack shaft axial force obtained by adding the roll rate-related estimated rack shaft axial force and the roll angle-related estimated rack shaft axial force) calculated by the rack shaft axial force estimating section 620.

In this way, the control variable correcting section 613 corrects the control variable calculated by the base control variable calculating section 611, with reference to the rolling-related estimated rack shaft axial force calculated by the rack shaft axial force estimating section 620. This makes it possible to apply, to a steering member 410, an assist torque or reaction torque which causes a driver to feel less discomfort.

### Embodiment 3

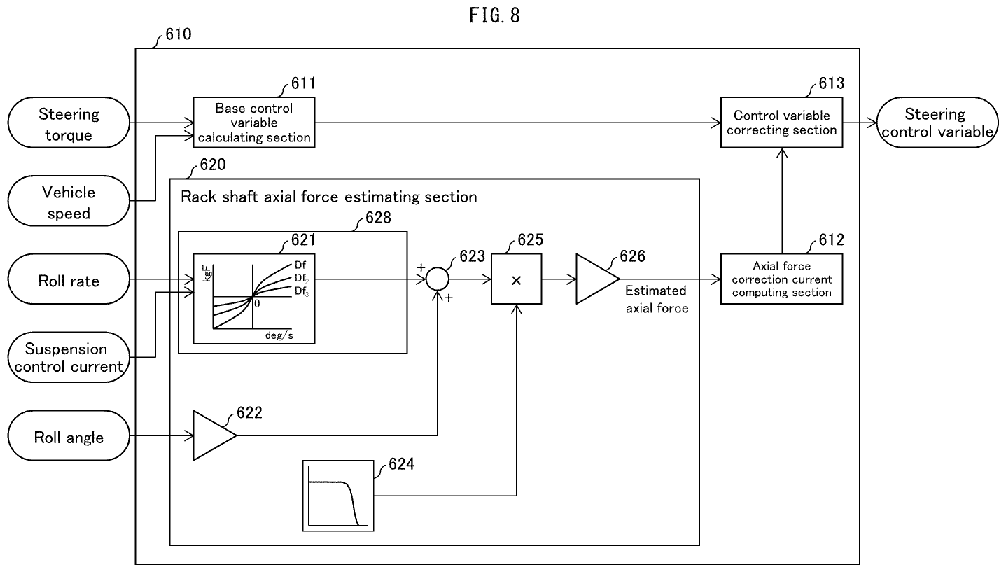

The following description will discuss Embodiment 3 of the present invention with reference to FIG. 8.

FIG. 8 is a block diagram illustrating an example configuration of a steering control section in accordance with Embodiment 3 of the present invention. The steering control section in accordance with Embodiment 3 has a configuration obtained by modifying the steering control section 610 in accordance with Embodiment 2 such that the rack shaft axial force estimating section 620 further includes the trail map applying section 624, a multiplying section 625, and the second constant gain applying section 626. Further, the steering control section in accordance with Embodiment 3 has a configuration obtained by modifying the steering control section 610 in accordance with Embodiment 2 such that the first constant gain applying section 627 is eliminated from the roll rate-related rack shaft axial force estimating section 628 and the third constant gain applying section (amplifier) in the roll angle-related rack shaft axial force estimating section 622 is eliminated.

In the following description, members which are the same as those already discussed are assigned the same referential numerals, and their descriptions are omitted.

As illustrated in FIG. 8, the trail map applying section 624 determines a correction factor with reference to a trail map. Note that the trail map used by the trail map applying section 624 may be estimated on the basis of angles of sideslip of tires 310 or may be estimated by a conventional technique.

The multiplying section 625 multiplies a rolling-related estimated damping force (an estimated damping force obtained by adding a roll rate-related estimated damping force and a roll angle-related estimated damping force) supplied from an adding section 623 by the correction factor supplied from the trail map applying section 624.

The second constant gain applying section 626 applies a gain in accordance with a vehicle 900 to an estimated damping force (an estimated rack shaft axial force obtained by multiplying a rolling-related estimated rack shaft axial force by the correction factor supplied from the trail map applying section 624) supplied from the multiplying section 625. More specifically, the second constant gain applying section 626 calculates an estimated rack shaft axial force by multiplying the estimated damping force (the estimated damping force obtained by multiplying the rolling-related estimated damping force by the correction factor supplied from the trail map applying section 624) supplied from the multiplying section 625 by a correction factor in accordance with the vehicle 900. Examples of the correction factor in accordance with the vehicle 900 encompass a gain in accordance with a caster angle β, a knuckle length Lkn, a tread width TW, a height Hg of a center of gravity, or the like.

In Embodiment 3, the first constant gain applying section 627 in the roll rate-related rack shaft axial force estimating section 628 and the third constant gain applying section in the roll angle-related rack shaft axial force estimating section 622 in accordance with Embodiment 2 are replaced with the second constant gain applying section 626.

Accordingly, in Embodiment 3, a combination of a roll rate-related suspension damping force estimating section 621 in the roll rate-related rack shaft axial force estimating section 628 and the second constant gain applying section 626 can be regarded as the roll rate-related rack shaft axial force estimating section 628, and a combination of a roll angle-related damping force estimating section in the roll angle-related rack shaft axial force estimating section 622 and the second constant gain applying section 626 can be regarded as the roll angle-related rack shaft axial force estimating section 622.

Therefore, it can be said that Embodiment 3 has a configuration in which a rolling-related rack shaft axial force is estimated on the basis of a roll rate-related rack shaft axial force and a roll angle-related rack shaft axial force.

Note that since the multiplying section 625 and the second constant gain applying section 626 are configured to multiply an estimated rack shaft axial force supplied from the adding section 623 by a correction factor in accordance with the vehicle 900, the multiplying section 625 and/or the second constant gain applying section 626 are/is also referred to as a vehicle state coefficient multiplying section.

As described above, the rack shaft axial force estimating section 620 in accordance with Embodiment 3 can estimate a rack shaft axial force with reference to a correction factor in accordance with the vehicle 900 in addition to the roll rate, the damping coefficient-related value, and the roll angle described above.

A control variable correcting section 613 generates a steering control variable by correcting, with use of a correction current supplied from an axial force correction current computing section 612, a control variable calculated by a base control variable calculating section 611. In other words, the control variable correcting section 613 corrects the control variable calculated by the base control variable calculating section 611, with reference to a rolling-related estimated rack shaft axial force (an estimated rack shaft axial force obtained by adding a roll rate-related estimated rack shaft axial force and a roll angle-related estimated rack shaft axial force) calculated by the rack shaft axial force estimating section 620 and a correction factor in accordance with the vehicle 900.

In this way, the control variable correcting section 613 corrects the control variable calculated by the base control variable calculating section 611, with reference to the rolling-related estimated rack shaft axial force (the estimated rack shaft axial force obtained by adding the roll rate-related estimated rack shaft axial force and the roll angle-related estimated rack shaft axial force) calculated by the rack shaft axial force estimating section 620 and the correction factor in accordance with the vehicle 900. This makes it possible to apply, to a steering member 410, an assist torque or reaction torque which causes a driver to feel less discomfort.

[Software Implementation Example]

Control blocks of the ECU 600 (particularly, the steering control section 610 and the suspension control section 650) can be realized by a logic circuit (hardware) provided in an integrated circuit (IC chip) or the like or can be alternatively realized by software as executed by a central processing unit (CPU).

In the latter case, the ECU 600 includes a CPU that executes instructions of a program that is software realizing the foregoing functions; a read only memory (ROM) or a storage device (each referred to as “storage medium”) in which the program and various kinds of data are stored so as to be readable by a computer (or a CPU); and a random access memory (RAM) in which the program is loaded. An object of the present invention can be achieved by a computer (or a CPU) reading and executing the program stored in the storage medium. Examples of the storage medium encompass “a non-transitory tangible medium” such as a tape, a disk, a card, a semiconductor memory, and a programmable logic circuit. The program can be supplied to the computer via any transmission medium (such as a communication network or a broadcast wave) which allows the program to be transmitted. Note that the present invention can also be achieved in the form of a computer data signal in which the program is embodied via electronic transmission and which is embedded in a carrier wave.

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

200 vehicle body
600 ECU (control device)
610 steering control section
611 base control variable calculating section
612 axial force correction current computing section
613 control variable correcting section
620 rack shaft axial force estimating section
621 roll rate-related suspension damping force estimating section
622 roll angle-related rack shaft axial force estimating section (second rack shaft axial force estimating section)
623 rolling-related rack shaft axial force estimating section (adding section, third rack shaft axial force estimating section)
624 trail map applying section (vehicle state coefficient multiplying section)
625 multiplying section (vehicle state coefficient multiplying section)
626 second constant gain applying section (vehicle state coefficient multiplying section)
627 first constant gain applying section (vehicle state coefficient multiplying section)
628 roll rate-related rack shaft axial force estimating section (first rack shaft axial force estimating section)
900 vehicle

1. A rack shaft axial force estimating device, configured to calculate an estimated value of a damping force of a suspension with reference to a roll rate of a vehicle body and estimate a rack shaft axial force on the basis of the estimated value of the damping force of the suspension.

2. The rack shaft axial force estimating device as set forth in claim 1, configured to estimate the rack shaft axial force, additionally with reference to a damping coefficient-related value.

3. The rack shaft axial force estimating device as set forth in claim 2, configured to estimate the rack shaft axial force, additionally with reference to a roll angle.

4. The rack shaft axial force estimating device as set forth in claim 3, comprising:
a first rack shaft axial force estimating section configured to estimate a first rack shaft axial force on the basis of the roll rate and the damping coefficient-related value;
a second rack shaft axial force estimating section configured to estimate a second rack shaft axial force on the basis of the roll angle; and
a third rack shaft axial force estimating section configured to estimate a third rack shaft axial force with use of the first rack shaft axial force and the second rack shaft axial force.

5. The rack shaft axial force estimating device as set forth in claim 2, wherein:
the damping coefficient-related value is a control variable for controlling the damping force of the suspension.

6. The rack shaft axial force estimating device as set forth in claim 3, wherein:
the damping coefficient-related value is a control variable for controlling the damping force of the suspension.

7. The rack shaft axial force estimating device as set forth in claim 4, wherein:
the damping coefficient-related value is a control variable for controlling the damping force of the suspension.
